(19) United States
(12) Patent Application Publication
(10) Pub. No.: US 2013/0030807 A1
(43) Pub. Date: Jan. 31, 2013

(54) WIRELESS SPEECH RECOGNITION TOOL

(71) Applicants: Stephen S. Burns, Maineville, OH (US); Mickey W. Kowitz, Loveland, OH (US); Michael F. Bell, Cincinnati, OH (US)

(72) Inventors: Stephen S. Burns, Maineville, OH (US); Mickey W. Kowitz, Loveland, OH (US); Michael F. Bell, Cincinnati, OH (US)

(21) Appl. No.: 13/630,769

(22) Filed: Sep. 28, 2012

Related U.S. Application Data
(63) Continuation of application No. 09/863,996, filed on May 23, 2001.

(51) Int. Cl. G10L 15/26

(52) U.S. Cl. 704/235; 704/E15.043

(57) ABSTRACT

The wireless voice recognition system for data retrieval comprises a server, a database and an input/output device, operably connected to the server. When the user speaks, the voice transmission is converted into a data stream using a specialized user interface. The input/output device and the server exchange the data stream. The server uses a programming interface having an engine to match and compare the stream of audible data to a data element of selected searchable information. A data element of recognized information is generated and transferred to the input/output device for user verification.

### CROSS REFERENCE TO RELATED APPLICATIONS

This application claims priority of U.S. Provisional Application Ser. Nos. 60/206,541, filed May 23, 2000 and 60/206,652, filed May 24, 2000.

### STATEMENT REGARDING FEDERALLY SPONSORED RESEARCH OR DEVELOPMENT

Not Applicable

### REFERENCE TO MICROFICHE APPENDIX

Not Applicable

### FIELD OF THE INVENTION

This invention pertains to a data retrieval system. More particularly, the invention pertains to a wireless voice recognition system for providing remote data retrieval and a method of using the system.

### BACKGROUND OF THE INVENTION

Conventional electronic handheld devices are known. Electronic devices, such as a handheld personal computer or a personal data assistant (PDA), may use operating systems, like the Palm OS or the Windows CE to create, store and exchange information.

Some electronic handheld devices can be operably connected through a wireless transmission mechanism, such as a wireless modem, enabling the user to wirelessly exchange data with a remote source through the telephone network. The ability to wirelessly exchange data with a remote source saves the user the time and money it may cost to personally retrieve or deliver the information.

In most cases, doctors and physicians provide drug prescriptions that are handwritten on a prescription pad. Unfortunately, in some cases, the doctor misspells or illegibly writes the prescription on the pad, and as a result the patient is given the wrong drug prescription. This type of error can not only be costly to the doctor, but also be potentially fatal for the patient.

The ability for a doctor to accurately retrieve patient or prescription information, confirm the accuracy of this information, and electronically write prescriptions, which may then be confirmed by the doctor, can save time as well as money. Accordingly, there exists a need for a low-cost accurate way to provide wireless accurate data retrieval

### SUMMARY OF THE INVENTION

It is desirable to provide a system for wireless voice activated data retrieval. The system comprises a server, a database, and an input/output device. The user speaks into the user interface associated with the input/output device. The user interface creates a data stream which is transmitted to an operably connected server.

The server receives a transmitted data stream from the input/output device, processes the transmitted data stream, and exchanges the data information with a recognition search engine.

The programming interface having a speech recognition search engine generates the modified second data stream by converting the first data stream to an intermediate data element and then generating and comparing information to a selected searchable data element. The modified second data stream is then verified and transmitted to the input/output device.

In one embodiment of the present invention, the system is configured to enable electronic prescription data retrieval.

In another example of the present invention, the user interface is a graphical user interface for providing electronic prescription retrieval.

### BRIEF DESCRIPTION OF THE DRAWINGS

The invention will be more readily understood by reference to the following description, taken with the accompanying drawing, in which:

FIG. 1 is a flow diagram of the wireless voice recognition system, in accordance with the present invention.

FIG. 2 is a schematic diagram of the server of the present invention.

FIG. 3 is a block diagram of the architecture of an embodiment of the present invention.

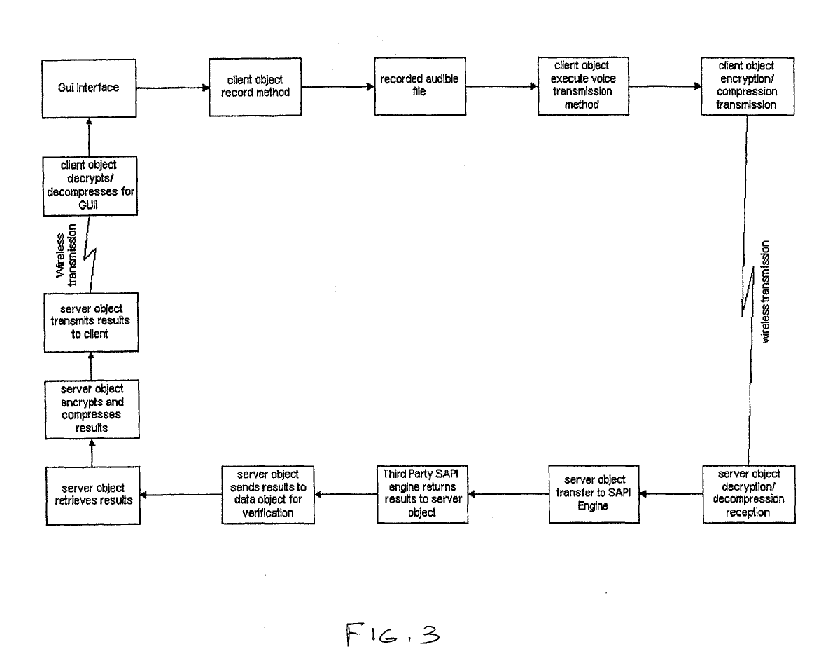

### DETAILED DESCRIPTION OF THE INVENTION

While the present invention is susceptible of embodiment in various forms, there is shown in the drawings an embodiment of the present invention that is discussed in greater detail hereafter. It should be understood that the present disclosure is to be considered as an exemplification of the present invention, and is not intended to limit the invention to the specific embodiment illustrated. It should be further understood that the title of this section of this application (“Detailed Description Of The Invention”) relates to a requirement of the United States Patent Office, and should not be found to be limiting to the subject matter disclosed herein.

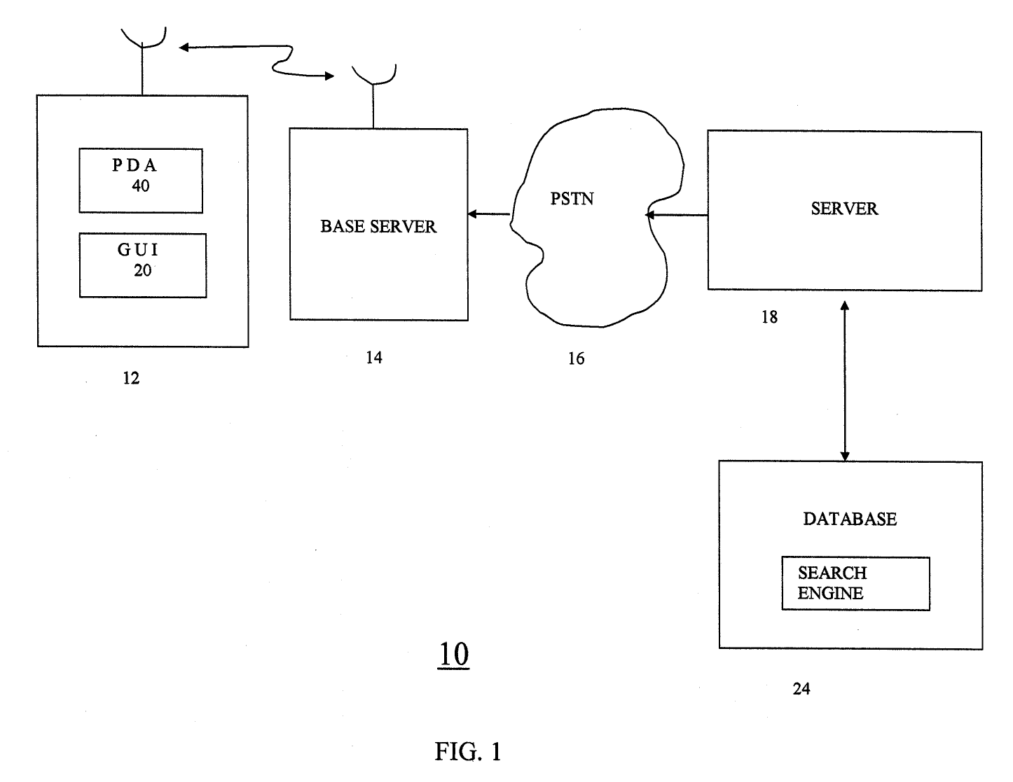

Referring now to drawings, more particularly FIG. 1, there a flow diagram illustrating a wireless voice recognition system 10, in accordance with the present invention, is shown.

The wireless speech recognition system 10 comprises a client 12, a server 18, a programming interface 26 having an associated search engine 28, selected searchable data 30, and a database 24 having a database engine.

The wireless speech recognition system 10 allows users to instantly exchange information with a remote server 18.

The client 12 comprises a wireless input/output device 40, having an operably connected user interface 42. It is contemplated that the input/output device 40 is generally an electronic instrument capable of retrieving, transmitting and storing information, such as a personal display assistant (PDA), a hand-held computer, or the like.

It is understood that the input/output device 40 uses an operating system, such as the PALM OS or WINDOWS CE operating system, enabling the input/output device 40 to interact or communicate with the connected user interface 42.

The input/output device 40 is wirelessly connected to the server 18, enabling bi-directional data exchange. It is contemplated that the input/output device 40 and the server 18 communicate using conventional forms of wireless communication. However, it is contemplated that the client and server can communicate over, a Local Area Network Systems (LANS), World Area Network system (WANS), satellite systems or any other network systems known to those skilled in the art.

Additionally, it is contemplated that the client 12 and server 18 have business-logic for the particular contemplated use of the wireless voice recognition system 10. For example, in one preferred embodiment, the client 12 and server 18 business-logic comprises business-logic for enabling electronic prescription writing by physicians.

The user interface 42 enables the input/output device 40 to exchange voice related data with the server 18. The user interface 42 comprises a recording apparatus, a transmission apparatus, an encryption/deencryption mechanism, and a compression/decompression mechanism. Preferably the user interface 42 is a speech-specific graphical-user-interface (GUI) configured to further enable voice detection, voice recordation, data transmission and data reception.

The GUI is programmed and configured according to user's desired specifications. For example, in one embodiment of the present invention, the GUI is configured and programmed to enable physicians and doctors to electronically write prescriptions.

Preferably, the GUI has custom controls for handling data transmittal and retrieval. The GUI can have a switch, button, softkeys, or the like, enabling the user to activate and deactivate the recording mechanism in the recording apparatus.

The GUI includes a viewable display and a textual data conversion application, enabling the user to view the retrieved data and view the data in a viewable format. The textual data conversion application converts received data from the server 18 into a textual format, such that the data can be viewed on the viewable display. It is contemplated that the GUI can further include a prompt, which appears on the viewable display, requesting user input.

Additionally, the GUI includes a speaker, enabling the user to listen to data received from the server or the Automated Speech Recognition engine, and an audible data conversion application for converting the received data received into an audible format, such that the data can be audibly listened to by the user.

The recording apparatus is configured for detecting and receiving the user's a voice transmission and recording the voice transmission into a data stream, which can be an audible data stream or a data element.

The recording apparatus includes a receiving device for detecting and receiving sound transmissions, such as a microphone. The recording apparatus records the user's voice transmission to the data stream, using sound recording methods such as a recording algorithm, software application or other sound recording applications known to those skilled in the art.

When the user speaks into the recording device, the recording device receives the voice transmission and transfers the voice transmission to the recording application. Preferably, the user interface contains specific workflow renderings of the speech in lists of viable form with one second or less recognition timings.

Notably, it is contemplated that instead of recording the data to a stream, the data stream can be transferred to the server in real-time.

The encrypting/de-encrypting mechanism encrypts or codes the data stream, enabling a secure and private data transmission. It is contemplated that the encrypting/de-encrypting mechanism uses encryption/de-encryption algorithms or methods known to those skilled in the art to perform the encryption/de-encryption function.

The compression/decompression mechanism compresses or decompresses the data exchanged between the connected server to enhance the speed of data transmission by reducing the size of data exchanged between the server. It is contemplated that the compressing/decompressing mechanism uses algorithms or methods known to those skilled in the art to perform the compression/decompression function.

The client 12 uses standard wireless communication protocols, generally known to those skilled in the art for communicating with the connected server. Preferably, the communication protocols can use both data compression and data encryption functions to provide fast, secure data transmission between the server and the device.

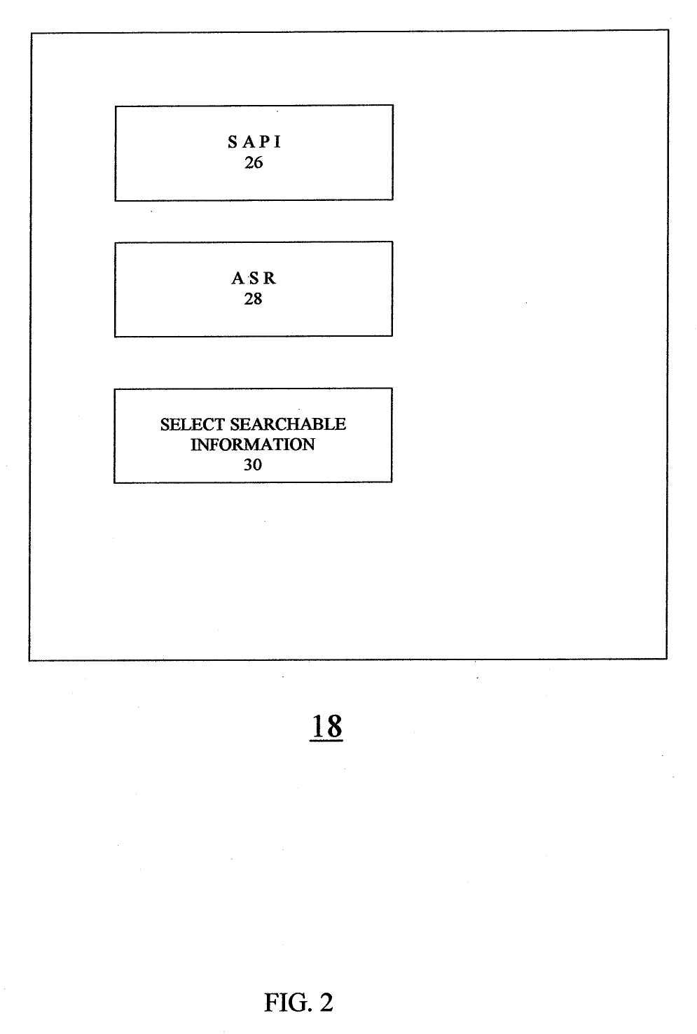

Referring now to FIG. 2, a server 18, in accordance with the present invention, is shown. As described above, the server 18 is connected to the client 12 using wireless communication protocols known to those skilled in the art. The server 18 includes a messaging or communicating mechanism, an encrypting/de-encrypting mechanism, a compression/decompression mechanism, an interface for the communicating with the programming interface and a database interface.

The messaging mechanism enables the server to bi-directionally exchange data with the wirelessly connected input/output device 40, using standard wireless communication protocols.

As previously described, the encrypting/deencrypting mechanism provides a secure, private data transmission with the input/output device 40. The encrypting/deencrypting uses algorithms or methods, which correspond algorithms and methods used by the client 12, such that the server 18 and client 12 can communicate.

The compression/decompression mechanism enhances the speed of data transmission by reducing the size of the stream using compression/decompression methods or algorithms known to those skilled in the art.

The server 18 interfaces with the programming interface 28 enable the exchange of data between the server 18 and the programming interface 28.

Selected searchable data 30 is provided to the programming interface 26, such that the recognition engine 28 can generate a stream of matching recognized data 30. The matching recognized data is generated by searching the selected searchable data for matching data elements contained in the transmitted stream and creating a matching data stream containing those matching data elements.

The selected searchable data 30 can contain any type of information or text desired. In one embodiment of the present invention, the select information contains a drug prescription data, such that the recognition engine will generate a recognized matching data that containing drug prescription information.

The wireless voice recognition system 10 uses the programming interface 26 to recognize and retrieve recognized information. Preferably, the programming interface 26 is a speech-application-programming-interface (SAPI). In the preferred embodiment, the SAPI 26 has a data search engine 28, preferably an automatic speech recognition (ASR) engine, for creating a stream of matching recognized data. Some examples of exemplary search engines 28 are the ASR1600 by Lemout & Hauspie, and the Philips Speech Engine.

The data search engine 28 searches the data contained in the selected searchable data 30 for matching information contained in the transmitted data stream, to create a data element of recognized matching data.

The recognized matching data element can be represented in the form of singly selected list of recognized matching information or an easily represented set of return lists. Notably, it is contemplated that the recognized information can be represented in any desired form, without departing from the scope of the present invention.

In an embodiment providing for electronic prescription writing, the search engine 28 provides matching group or set of information related to the recognized words contained in the transmitted data stream. For example, upon recognition of the word “antibiotics” a group of related words are generated.

In another embodiment, the ASR would provide singly selected information upon recognition of the word having a specified meaning, such as “penicillin”.

In another embodiment, the ASR engine is provided selected searchable data 30 containing appropriate technical terms or dictionary, for recognition of technical or specialized words relating to the particular use contemplated for the wireless voice recognition system 10.

For example, in the case of electronic prescription writing, the search engine comprises a technical dictionary of prescription-related terms, including, for example, drug names, diagnosis-related information, and prescription information.

The ASR engine 28 is configured with a speech synthesis subsystem, which enables the engine to communicate with, the client 12. The engine 28 has the ability to accept learned dialects and voice diction through the wireless connection and returning and messaging newly learned dialects of speech to the recognition engine.

These speech synthesis algorithms direct the user's response through a speaker built in to the handheld device or alternatively through a headphone jack, or similar output device contained in the client. The speech synthesis subsystem returns an audible transmission of words having similar pronunciations such that the user can verify the accuracy of the selected element. This is helpful in situations learning a new dialect, or alternatively when pronunciation becomes apparent.

The database 34 contains specific data for verification. The recognized matching data is compared to the data in the database 34 to verify the accuracy of the recognized matching data. Verified data is transferred back to the server 18 for transmission to the client 12.

In the use of the voice recognition data retrieval system 10 described above, the user speaks into the user interface 42, which is operably associated with the input/output device 40. The recording apparatus, such as a microphone or speech detection device, detects the voice transmission and records the voice transmission to a data stream. The recorded data stream is then transferred to a transmission mechanism. In one embodiment, the user interface provides an encryption mechanism which encrypts the data element enabling secure, private data transmission.

In a second embodiment, the user interface provides a compression mechanism, which compressed the data element, for enhancing the speed of transmission.

The data element is transmitted to the server using wireless communication means, according to standard wireless communication protocols known to those skilled in the art. The wireless transmission is then received by the server, which decrypts/decompresses the wireless transmission according to the appropriate algorithms that were used to encrypt/compress the transmission.

The data element is transferred to the programming interface 26 having a recognition engine 28. The recognition engine 28 compares and matches the information contained in the transmitted data stream to the selected information 30d to generate a data element of recognized matching data.

The engine 26 then sends the resulting matching recognize element to the server. The server sends recognized data element to a connected database 34 for verification, wherein the recognized data element is matched and compared to data contained in the database. The matching verified data element is sent to the server 18.

In one embodiment of the invention, the server 18 encrypts and compresses verified data elements and transmits the data element to the client 12 using wireless transmission protocols.

The client's user interface receives the wireless transmission, and the results are decrypted and decompressed using the decryption and decompression mechanisms. The interface displays or audibly transmits the data thereby providing the user with recognized data according to his or her voice transmission.

In another embodiment of the voice recognition system 10, the data transmission between client 12 and the server is performed asynchronously. For example, while the recorded audible stream or data stream is being detected, streaming data packets in a controlled packet environment can be transmitted asynchronously to the server. The server then transmits the received data packets and transfers them to the SAPI search engine 28. The SAPI engine 28 to interprets these data packets while additional recorded data packets are being created inputted by the user on the client 12.

Similarly, when the server returns the verified results, data packets comprising the verified results can be returned to the client 12 while the database 34 continues to process the returned results and verify the accuracy.

Those of skill in the art will appreciate that the server does not always have to stream recorded audible data into the SAPI engine 26. There are instances in which the server object must receive the entire recorded audible stream before sending that stream to the SAPI engine.

In a preferred electronic prescription data retrieval embodiment, the user interface 42, particularly the GUI prompts the user to provide input, such as a patient's name, or a prescription. The user indents the buttons or soft keys on the input/output device 40, activating the recording apparatus. The user orally speaks the requested information into the user interface 42. The recording apparatus records the data to a data stream. Notably, the recorded audible stream need not be a physical file, but can be a buffered stream. It is contemplated that the recorded audible stream can be any type of stream interfaceable with the input/output device 40.

The recorded data stream, and data query, are encrypted and compressed according to known encryption and compression algorithms and transmitted to the connected server 18. During the execute method, the user interface 42 sends a data query requiring that the server 18 compare the recognized data generated by the search engine 28 to information contained in the database 34.

The data stream and data query is received by the server and decrypted and decompressed. The server 18 sends the data to the programming interface 26, such that search engine 28 can for compare and match the transmitted data stream to the provided selected searchable data.

The SAPI engine 28 returns the appropriate recognized matching information that matches the transmitted data to the server 18. For example, if the user's spoken words were “John Doe,” the recognition engine 28 would return matching data in the database that the recognition engine believes matches the spoken words, such as for example, “John Doe” “Jonathan Doe” or “Jane Doe.”

The server 18 verifies the matching recognized data by comparing the data to the information stored in the selected database 34. The database 34 uses a comparison engine to compare the matching recognized data to data contained in the database. The server retrieves the results based on the comparison to the database. The server then transmits the recognized matching data and the data query results. In this example, the database only contains a patient named “John Doe” and therefore only returns the result “John Doe.”

The verified matching data, in this case “John Doe,” is then encrypted and compressed for wireless transmission back to the client 12.

The input/output device 40 receives the wireless transmission, and decrypts and decompresses the returned results. The results are then transferred to the GUI 12. The GUI then further manipulates the data as required.

It is contemplated that if the results return with a predetermined value of confidence such as 95%, the GUI proceeds to the next data input screen. If the results are returned with an 85% confidence, the GUI can be programmed to allow the user to verify the returned results.

The described embodiments of the invention are intended to be merely exemplary and numerous variations and modifications will be apparent to those skilled in the art. All such variations and modifications are intended to be within the scope of the present invention.

1. A system for providing wireless voice activated data retrieval comprising: a client, a server; a database; an input/output device, and a database engine, operably connected to the server, said input/output device capable of receiving voice of a user and converting it to a data stream, and a communication apparatus, capable of enabling the exchange of information with the server; the server being capable of receiving a transmitted data stream from the input/output device, processing the transmitted data stream by way of speech recognition techniques in order to convert the transmitted data stream to a second data stream of text data representative of the voice data from the user and thereafter directing the second data stream to said database for comparing said second data stream with data in said database that is unrelated to speech processing and returning the results of that comparison back to said input output device.

2-28. (canceled)

29. A system for checking whether data provided by a client can be correlated with data contained in a database, the system comprising:
a client having an input/output system for receiving voice data and converting said voice data to a first data stream, said input/output system also including a bi-directional communication system for communicating wirelessly over a wireless communication link with at least one external server; and
said at least one external server comprising:
a bi-directional communication system for communicating with said client;
a speech recognition system that includes a speech recognition engine for comparing the data in said first data stream with stored speech data to determine if the first data stream correlates with the said stored speech data and generating recognized voice data when said first data stream correlates with said stored speech data;
a database for storing selected information; and
a database engine for receiving said recognized voice data and comparing said recognized voice data with said selected data to verify that said recognized voice data corresponds to said selected information in said database and returning an indication to said client when said recognized voice data is verified.

30. The system as recited in claim 29, wherein said input/output system includes an encryption/decryption system for encrypting said first data stream before it is transmitted to said server and decrypting data received from said at least one server.

31. The system as recited in claim 29, wherein said input/output system includes a compression/decompression system for compressing said first data stream before it is transmitted to said server and decompressing data received from said at least one server.

32. The system as recited in claim 30, wherein said at least one server includes a decryption/encryption system for decrypting said first data stream from said client and encrypting data before it is transmitted to said client.

33. The system as recited in claim 31, wherein said at least one server includes a decompression/compression system for decompressing said first data stream from said client and compressing data before it is transmitted to said client.

34. The system as recited in claim 29, wherein said selected information in said database is a list of patients and said database search engine compares the recognized voice data with said list of patients.

35. The system as recited in claim 29, wherein said indication refers to transmitting data from said database to said client.

36. The system as recited in claim 35, wherein said data transmitted from said database to said client is encrypted and compressed.

37. The system as recited in claim 36, wherein said input/output system includes an decryption and decompressing system for decrypting and decompressing said data from said database received from said at least one server.

38. The system as recited in claim 37, wherein said input/output system includes a display for displaying said data from said database received from said at least one server.

39. A wireless medical prescription writing system comprising:
a client having an input/output system for receiving voice data and converting said voice data to a first data stream, said input/output/system also including a bi-directional communication system for communicating with at least one server; wherein said at least one server comprises:
a bidirectional communication system for communicating with said client;
a voice recognition engine for receiving said first data stream and determining if the first data stream correlates with stored speech data and generating recognized voice data when said first data stream correlates with said stored speech data;
a database for storing medical information; and
a database engine for receiving said recognized voice data and comparing said recognized voice data with said medical information to verify that said recognized voice data corresponds to said medical information in said database and returning an indication to said client when said recognized voice data is verified.

40. The wireless prescription writing system as recited in claim 39, wherein said medical information includes patient information.

41. The wireless prescription writing system as recited in claim 39, wherein said medical information includes prescription information

42. A method for providing medical prescriptions, the method comprising:
(a) providing voice data corresponding to medical prescriptions;
(b) converting said voice data to a data stream;
(c) converting said data stream to recognized voice data; and
(d) comparing said recognized voice data with medical data stored in a database to determine if said recognized voice data correlates to medical data stored in said database;
(e) providing a visual indication when said recognized voice data correlates to stored medical information.

43. The method as recited in claim 42 wherein said medical data includes patient data.

44. The method as recited in claim 42 wherein said medical data includes prescription data.
